(19) United States
(12) Patent Application Publication
(10) Pub. No.: US 2003/0183685 A1
(43) Pub. Date: Oct. 2, 2003

(54) Coding, tracking and reporting negotiable items and related non-negotiable documents

(75) Inventors: Jane M. Steele Moore, Toronto (CA); George W. K. Moore, Toronto (CA); Keri A. F. Johnston, Toronto (CA); Darin R. Renton, Toronto (CA)

Correspondence Address: WEINGARTEN, SCHURGIN, GAGNEBIN & LEBOVICI LLP, TEN POST OFFICE SQUARE, BOSTON, MA, 02109, US

(73) Assignee: Code & Track Inc.

(21) Appl. No.: 10/400,037

(22) Filed: Mar. 26, 2003

Related U.S. Application Data
(60) Provisional application No. 60/367,827, filed on Mar. 27, 2002.
(60) Provisional application No. 60/424,867, filed on Nov. 8, 2002.

(51) Int. Cl. G06F 17/60

(52) U.S. Cl. 235/379

(57) ABSTRACT

A system and a method for coding, tracking, and reporting on items from any one or more processing points for institutions. The system operates to affix, apply or print codes on or to items and documents, in the form of one or more bar codes and/or related symbology. The system operates to also read codes previously printed, affixed or otherwise applied to items and documents. The information related to and represented by the codes and/or related symbology is used during the issuing, clearing, settlement and/or exchange processes and other types of processes throughout the lifecycle of the item. The specific information encoded in the bar code and/or related symbology may, for example, include required any one or more of the following pieces of information regulatory details, processing and handling point identifications and tracking details, and other information. The disclosed system may further be embodied such that the information included in the bar codes and/or related symbology on the item and document is supplemented with information stored in an associated database and other electronic or paper based information repositories. Report generation based on the information encoded within the bar codes and/or related symbology, and on associated information in the software database or other electronic or paper based information repositories is also disclosed.

### CROSS REFERENCE TO RELATED APPLICATIONS

This application claims priority under 35 U.S.C. §119(e) to U.S. provisional patent application serial No. 60/367,827 filed Mar. 27, 2002, entitled “PROCESS AND SOFTWARE FOR CODING, TRACKING AND REPORTING ON NEGOTIABLE AND NON-NEGOTIABLE ITEMS FROM POINT OF ACCEPTANCE AT A FINANCIAL INSTITUTION”, and also to U.S. provisional patent application serial No. 60/424,867 filed Nov. 8, 2002, and entitled “SYSTEM AND METHOD FOR ASSIGNING AND/OR MONITORING BAR CODES AND/OR RELATED SYMBOLOGIES AT ANY ONE OR MORE STAGES IN THE LIFECYCLE OF NEGOTIABLE INSTRUMENTS OR CURRENCIES AND RELATED NON-NEGOTIABLE ITEMS AND DOCUMENTS”.

### STATEMENT REGARDING FEDERALLY SPONSORED RESEARCH OR DEVELOPMENT N/A

### BACKGROUND OF THE INVENTION

The present invention relates generally to systems and methods for processing paper and electronic negotiable items, a term that includes currencies and all other types of paper or electronic items considered as negotiable forms of payment items or images of the paper or electronic negotiable items, and related non-negotiable documents in paper or electronic formats or images of the non negotiable documents, and more specifically to a process and software for coding, tracking, and reporting on negotiable items and related documents as described in this document.

As used herein, the term “institution” is used to refer to banks and other financial institutions including governments, government appointed agencies and departments, corporations owned and operated by or for banks or other financial institutions, independent processing centers or corporations, clients, intermediaries and participants or any electronic technology or equipment connected to any of the listed agencies, entities or persons, and any person or entity that accepts items as tender or payment.

Negotiable items are widely used in many countries throughout the world, under various specific names. As used herein, the term “item” is used to refer to any type of paper and electronic negotiable instrument and Bills of Exchange including currencies or images of paper or electronic negotiable instruments and Bills of Exchange including currencies.

As used herein, the term “document” is used to refer to any type of non-negotiable paper or electronic record used by an institution to complete one or more processes linked to an item.

Further for purposes of explanation, when an item such as a check is used to make a payment, the institution holding the account on which the funds are drawn is referred herein as the “issuing institution.” Similarly, the institution to which an item such as a check is presented for payment is referred to herein as the “accepting institution.” Transactions involving items are hereafter referred to simply as “transactions.”

In order to effectively manage the ongoing business of an institution, various pieces of information regarding the processing of an item and document by an accepting institution must be collected, maintained and accessed. The processing of an item and document by an accepting institution must be performed in a way that allows information regarding individual or multiple items to be easily and accurately collected, accessed and analyzed.

For example, information regarding transactions involving checks and other items must be sent from accepting institutions to issuing institutions or other institutions involved in the processing of the items. In many existing systems, this exchange of information requires the physical transfer of the items and documents themselves, or electronic versions of the items and documents. The process, by which the institutions exchange various types of items, including checks, whether in paper or electronic form, is referred to as “clearing.” As a result of such processes between institutions, outgoing value flows are netted against incoming value flows. The process of “settlement” occurs when institutions “settle” for the net amounts passing through their cumulative respective accounts. For example, settlement may be accomplished at a central banking institution, which facilitates the processes of clearing and settlement, as in the case of a national payments system.

In many existing systems, the preprinted information on various specific types of items provides identifying information pertaining to the issuing institution. This results in asymmetry with regard to information encoded onto items, such that information regarding issuing institutions is often provided by a code printed onto the item, while information reflecting the processing in the accepting institution is not. The accepting institution must accordingly apply endorsements, i.e. ink stamps, to most items it receives. Often such stamps are not clear or complete. Subsequent stamps or printing of details, for example on the reverse side of an item, often becomes cluttered and illegible creating confusion and errors when attempting to track the processing of items. FIG. 1 is an illustration of an item stamped and otherwise identified in accordance with the prior art techniques. As shown in FIG. 1, the various ink stamps on the item obscure one another, and become more and more unreadable as the item is processed.

Another significant shortcoming of existing systems is that details regarding processing of a specific item may often only be determined by physically locating the item or image of the item. Even when an item is located the next step using current systems is to create an audit trail that tracks the processing of the item. The creation of the audit trail is both time consuming and costly. Accordingly, in the event that an item becomes lost, misplaced or damaged prior to imaging, or should the imaging not be clear, important details may be permanently lost. Moreover, existing systems involving stamping of individual items are slow, and the errors introduced by the use of stamps increase handling time. Such increases in handling time may adversely affect the overall business performance of an institution, since financial resources may be poorly allocated, based on relatively old information regarding potentially large amounts of transactions.

Because the amount and detail of information provided by existing systems regarding processing of items following acceptance at any one or more entry points is currently so limited, business management process improvement, workflow processes, process resource allocation and process monitoring are all very difficult. This results in poor allocation of processing resources, and impact service levels and the ability to meet processing deadlines, some of which may be regulatory requirements. Moreover, the limits on information collected regarding item processing in existing systems prevent accurate accountability with regard to specific processing points, thus limiting the information institutions can obtain with regard to pinpointing process errors or bottlenecks. Detailed information would further be desirable for correcting specific errors with regard to individual items.

For the reasons stated above and others including resulting costs to both the institution and clients of the institution, it would be desirable to have a new system for processing and handling items during issuance, acceptance, clearance, settlement, exchange and post-exchange processing following acceptance at one or more of the entry point(s) of an institution. The new system should advantageously eliminate or significantly reduce any need for stamping items or providing other forms of identification with following issuance or acceptance at one or more of the entry point(s) of an institution. Additionally, the new system should improve the timeliness of handling and processing of items, increase security, improve accountability, reduce delays in correcting errors, and reduce the time required to deal with problems and errors that result from the mismanagement and mishandling of items and documents.

### BRIEF SUMMARY OF THE INVENTION

In accordance with the present invention, systems and methods for coding, tracking, and reporting on items and documents from any one or more points of creation, issuance, and acceptance or entry at an institution are disclosed. The disclosed system operates to encode, in one or more bar codes and/or related symbologies that are associated with an item and document, one or more pieces of information that may be used during the issuing, clearing, settlement, exchange and other processing activities throughout the lifecycle of that item and document. The specific information encoded in the bar code and/or related symbology on the item may, for example, when scanned or linked to a database or other electronic or paper based information repository provide details on the required regulatory information, processing point identifications and tracking details, and other information. The disclosed system may further be embodied such that the information contained in or represented by the bar codes and/or related symbology on the items is supplemented with information stored in an associated database. Report generation based on the information encoded within the bar codes and/or related symbology, and on associated information in the software database is also disclosed. In this way, the disclosed system provides symmetry between the issuing institution and the accepting institution with regard to information encoded onto the item.

Additional bar codes and/or related symbology may be added at different points in the processing of each item and document, or in response to a determination that an item requires special processing and handling. Such special processing may, for example, be in response to a determination that the amount of an item is greater than a predetermined limit, or to some other predetermined condition being met.

The disclosed system provides a method for identifying the exact entry point of an item before the item and document leave the accepting institution or another institution for clearing, settlement, exchange or any other processing activities. The system further allows for subsequent identification and tracking of items and documents at all lifecycle stages or processing points.

The system also provides for identifying each point of processing and handling throughout the entire lifecycle of any type of item including transactional and safekeeping processes and at any entry or exit points of an institution.

The system further allows for the inclusion of standard or customized processing instructions from any point of entry through each point of processing throughout the lifecycle of the items. In an illustrative embodiment, the present system employs an identification, tracking and record keeping process that follows an item from the point of issuance and acceptance for any reason or processing stage or entry at one or more entry point(s) of an institution through to the final steps required to complete the processing of each transaction. In this way, the disclosed system enables an institution to determine precisely where and when each stage of the processing for a specific item took place. For example, the disclosed system may be used to enable institutions to account for individual items from the time of acceptance or entry from one or more points, rather than grouping unaccounted items together for a total deposit that is released to another location for further processing and handling.

The disclosed system provides detailed information on each item, and enables details regarding processing of the item to be conveniently stored in a database, separate and intact from the item itself. Use of the associated database enables reports to be generated at any point in time. In an embodiment in which an item is imaged at the point of acceptance at one or more entry points of an institution, the disclosed system provides improved accuracy of data entered manually, improved speed at which information is gathered and collected, improved accountability, enhanced security and efficiency. The disclosed database system supports coding and tracking items from the time of acceptance at an institution, until final processing of the item is completed, including any related customer service processes.

The disclosed system is further applicable. In an operational environment in which electronic check presentment or check truncation is used, such that a check is scanned at the point of use or entry to an institution, the steps of associating the bar code with an item may be performed using the electronic copy or image of the check. In such an embodiment, a bar code added at the point of presentment or other processing points may accordingly be associated with the electronic copy or image of the check resulting from the scanning of the check. The bar code and/or other symbology can also be scanned or otherwise read directly from a computer screen to expedite processing.

In another embodiment, the disclosed system may be used by an issuing institution to provide a bar code on the checks issued by that institution to its customers. In such an embodiment, the current practice of using Magnetic Ink Character Recognition (MICR) and Optical Character Recognition (OCR) technologies may advantageously be eliminated in some situations.

In another embodiment, the disclosed system is further applicable when an issuing institution uses a bar code on currency that could eliminate or complement the practice of using serial numbers.

The disclosed system for processing items during clearance, settlement and exchange processing advantageously eliminates the need for stamping items following acceptance at any one or more entry or exit points of an institution. The new system also improves the timeliness of handling and processing of items, increases security, improves accountability of processing points, and reduces delays in identifying and correcting errors. These advantages are provided by the disclosed system providing coding information on items that reduces the amount of time and resources required to locate processing details and actual documents. This bar coded information facilitates the precise identification of where and when an item was last processed, used or handled. Accordingly, tracking back to a problem using the audit trail created in the processing of a bar coded item can be done automatically by scanning a code from a document, directly from a computer screen, item or image of the item or manually entering a code for an item. For example, images of an item may be automatically associated with a bar code and/or related symbologies identifying an item in the database when they are captured at the point of acceptance at any one or more entry points an institution. Moreover, the disclosed coding, tracking and record keeping database provides detailed information and other record keeping data that can be used to produce regulatory and business related reports at any desired frequency, and in either paper or electronic images.

The disclosed system operates such that reporting capabilities realized from the disclosed system enhance data access and analysis functionality and accessibility. Overall, the disclosed system provides significant improvements to business management processes while creating workflow-automation processes that increase efficiency. The disclosed system allows institutions to quickly respond to changing business conditions and service fulfillments. Additionally, the disclosed system provides significant security enhancements against unforeseen events that could result in the loss and destruction of items, damage to any one or more parts of a national clearing system and other unfortunate events.

The disclosed systems and methods allow institutions to communicate processing information expeditiously to other institutions to help reduce potential misuses and mishandling of items. For example, when an item is currency, items bearing duplicated bar codes can be deemed ineligible and recalled or destroyed immediately.

Another example of the use for the disclosed systems and methods involves an item in the form of currency, when that item is created, distributed, and circulated for use during the lifecycle of the item it is difficult to control and track the uses and misuses of that item. The disclosed system when applied to that item allows institutions responsible for controlling, issuing, distributing, circulating, accepting, recalling, destroying and otherwise processing currency throughout its of the lifecycle to track the item from any one or more points. The system can track the item including transactions resulting from the use(s) of the item.

In addition to the reasons stated previously in this document, the adoption and implementation of the process and system to track items such as currency is advantageous for institutions in particular government and law enforcement agencies as it provides control and allows for tracking of the uses of the item as well as misuse and mishandling of the item.

Managing activities such as recalling or determining the eligibility of the item and destroying an item such as currency can be controlled and completed using the system. Monitoring activities related to the misuse of an item in a form such as currency can be used to identify processing and handling problems as well as users responsible for activities deemed to be illegal.

### BRIEF DESCRIPTION OF THE SEVERAL VIEWS OF THE DRAWING

The invention will be more fully understood by reference to the following detailed description of the invention in conjunction with the drawings, of which:

FIG. 1 is an illustration of an item stamped and otherwise identified in accordance with the prior art techniques;

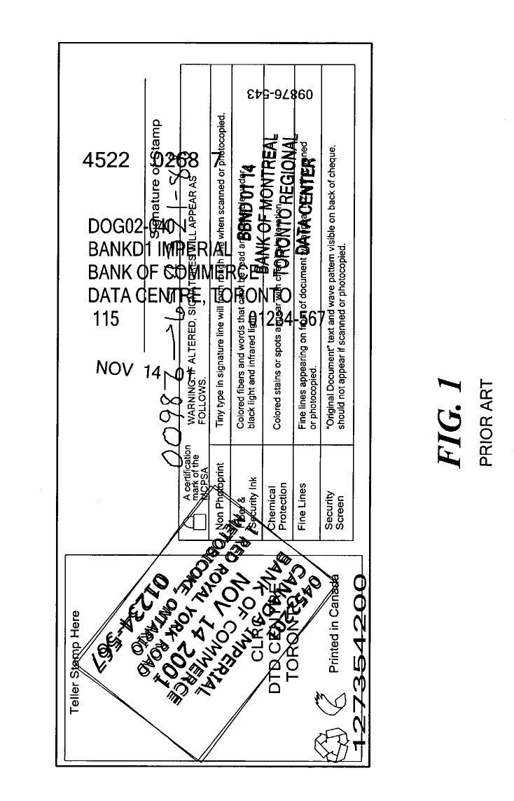

FIG. 2 is a flow chart showing some of the steps performed at any one or more entry points for an institution in an illustrative embodiment;

FIG. 3 is a flow chart showing some of the steps performed in an illustrative embodiment;

FIG. 4 is a flow chart showing steps performed receiving an item for acceptance at any one or more entry points of an institution in an illustrative embodiment;

FIG. 5 is a flow chart showing steps performed preparing and sending an item and document for clearing, settlement, exchange and post processing activities in an illustrative embodiment;

FIG. 6 is a flow chart showing steps performed for clearing, settlement, exchange and post processing in an illustrative embodiment;

FIG. 7 is a flow chart showing steps performed during post clearing, settlement and exchange processing in an illustrative embodiment;

FIG. 8 shows examples of bar codes, as may be used in an embodiment of the present invention;

FIG. 9 illustrates the regions within the surfaces or area of an item in which bar coding and/or related symbology may be assigned through a printing method or affixing a label;

FIG. 10 illustrates the regions of an item within the surfaces or area where bar coding and/or related symbology may be assigned through a printing method or applying or affixing a label;

FIG. 11 shows how bar coding and/or related symbology may appear in any space on the front or back of an item;

FIG. 12 shows an example of a display screen provided in an illustrative embodiment for displaying a summary of a teller's deposit including a listing of each item in the deposit;

FIG. 13 shows an example of a display screen provided in an illustrative embodiment for displaying an individual item listing report to be sent to a processing site for tracking, balancing and record keeping purposes;

FIG. 14 shows an example of a display screen provided in an illustrative embodiment for displaying a sample settlement and exchange report;

FIG. 15 shows an example of a display screen provided in an illustrative embodiment for displaying a sample tracking and processing report; and

FIGS. 16a, 16b and 16c show the types of information that can be associated with one or more bar codes and/or related symbologies printed, applied or affixed to an item, or pieces of information on the documents and items;

FIG. 17 shows an example of the lifecycle of an item from creation through to archiving and destruction; and

FIG. 18 is a flow chart showing some of the steps performed at any one or more stages in the lifecycle of an item such as currency in an illustrative embodiment.

### DETAILED DESCRIPTION OF THE INVENTION

All disclosures of U.S. provisional patent application serial No. 60/367,827 filed Mar. 27, 2002, entitled “PROCESS AND SOFTWARE FOR CODING, TRACKING AND REPORTING ON NEGOTIABLE AND NON-NEGOTIABLE ITEMS FROM POINT OF ACCEPTANCE AT A FINANCIAL INSTITUTION”, and U.S. provisional patent application serial No. 60/424,867 filed Nov. 8, 2002, and entitled “SYSTEM AND METHOD FOR ASSIGNING AND/OR MONITORING BAR CODES AND/OR RELATED SYMBOLOGIES AT ANY ONE OR MORE STAGES IN THE LIFECYCLE OF NEGOTIABLE INSTRUMENTS OR CURRENCIES AND RELATED NON-NEGOTIABLE ITEMS AND DOCUMENTS” are hereby incorporated herein by reference.

The disclosed system applies bar codes and/or related symbologies and/or text printed, applied to or otherwise affixed to or appearing on items received or otherwise entered at any one or more entry points for an institution. The bar coding and/or related symbologies of the disclosed system provides identification of the exact issuance and entry point for an item, each processing point and a record of each item and document before the item leaves any one or more entry points of an institution for circulation, distribution, pre clearing, clearing, settlement, exchange, recall, archiving, destruction, and other processing activities.

The disclosed system further allows for bar coding and/or related symbology to provide subsequent identification and tracking of an item and documents at any one or all stages in the processing throughout the lifecycle of the item and document. When the system is used to track an item such as currency, identification and tracking by the system and the process is the same when applied to the usage and transactions applicable to currency throughout the lifecycle of that item.

Accordingly, the disclosed identification and tracking process follows an item and documents throughout the lifecycle of the item and document from a point of issuance and acceptance at any one or more entry points of an institution through to the final processing steps. As a result, the institution will have the capability to precisely determine where and when each stage of processing took place for each item that it accepts or uses for processing at any one or more points throughout the lifecycle of the item and document. The disclosed system thus provides more detailed information on the processing of each accepted item and related documents, and with the disclosed database, the details of such processing may be stored separately from the item and related documents. Advantageously, detailed reports are readily available at any point in time. In particular, in an embodiment in which items are scanned or otherwise read, imaged or information is input into the database at any point throughout the lifecycle of the item a very high degree of security and efficiency may be provided for an institution.

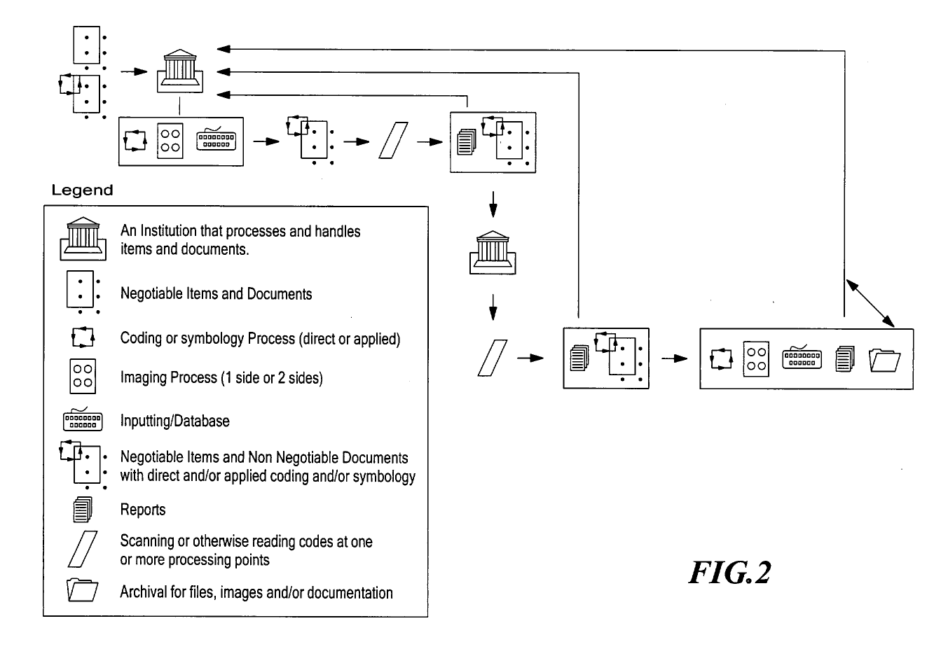

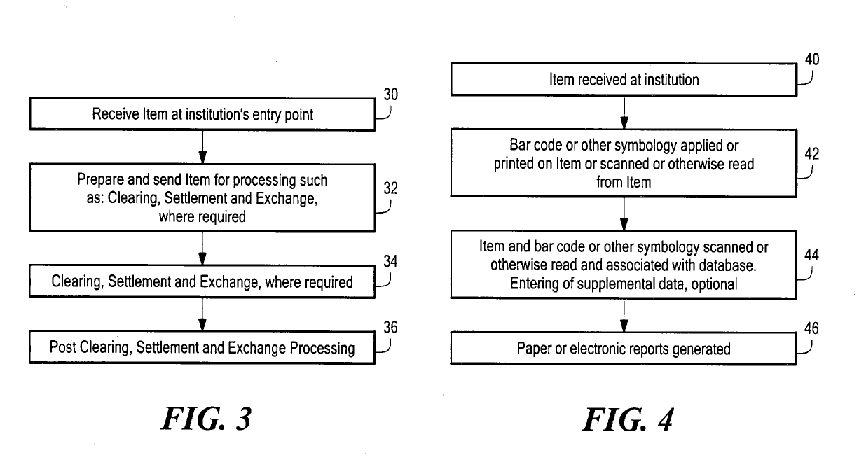

As illustrated in FIGS. 2 and 3, the disclosed system provides for assignment or scanning of the bar code and/or related symbology, capture of the item, adding additional bar codes and/or other symbologies or supplemental information required to process the item, recording, storing and archiving of the item and document at one or more entry points. At step 30 of FIG. 3, an item is received for acceptance at any one or more entry points of an institution. The entry point may, for example, be a teller at a bank or an automated banking or teller machine or processing site.

At step 32 the item is prepared for processing such as: clearing, settlement and exchange. Next, at step 34, the item is processed for clearance, settlement and exchange. At step 34 clearing, settlement and exchange processing is performed on the item. Finally, at step 36, the disclosed system facilitates examples of post clearing processing, settlement and exchange processing.

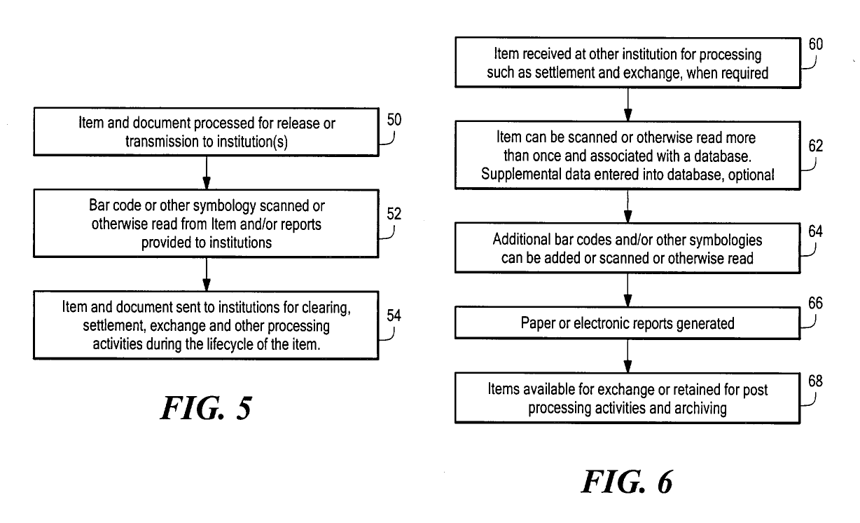

FIG. 4 further illustrates the disclosed system operation with respect to step 30 of FIG. 3, in which the item is initially processed when it is at any one or more entry points of an institution. As shown in FIG. 4, at step 40 an example of the item is first received at a point of entry for an institution. At step 42, the item processed by the application, scanning, printing or affixing of a bar code and/or related symbology on the item. Further at step 42, one or both sides of the item can be used for subsequent processing steps using the process and software in this embodiment. At step 44, the item is scanned or otherwise read, thus recording the one or more of the previously applied, affixed or printed bar code and/or related symbology. An entry in an associated database is created for the item, and the bar code(s) and/or related symbology details for the item is scanned or otherwise entered into or as part of the database entry created or associated with the item. The associated database may, for example, be a relational database or system(s) used by an institution. Supplemental information may also be entered into the database and associated with the item at step 44, for example through a graphical user interface provided by the disclosed system for this purpose to a user at the one or more of the entry points of an institution. At step 46, the disclosed system operates to provide one or more reports reflecting processing or handling activity involving the item. The generated reports may be in either paper or electronic form, and used to support various pre-clearing, settlement exchange processing activities or any other types of reports required or requested by an institution. The reports generated at step 46 may be formatted as needed by an institution.

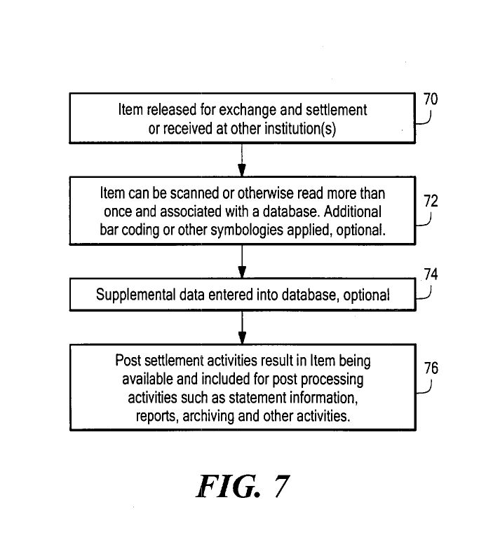

FIG. 5 shows steps corresponding to step 32 of FIG. 3, in which the item is prepared and sent for clearing, settlement and exchange or other processing and handling activities in an illustrative embodiment. At step 50 of FIG. 5, processing of the items for processing by another institution is initiated, and at step 52, the bar code and/or related symbology previously associated with the item may be scanned again and as many times as required. Further at step 52, the disclosed system may operate to send one or more reports, in either paper or electronic form, reflecting processing steps performed with respect to the item, to one or more institutions. At step 54, the item is sent, in either paper or electronic form, to one or more processing sites of the institution for clearing, settlement, exchange, post settlement activities and any other processing and handling activities. The item may be accompanied by supporting information or documents reflecting processing of the item and other item, for example in the form of one or more reports, when it is conveyed at step 54.

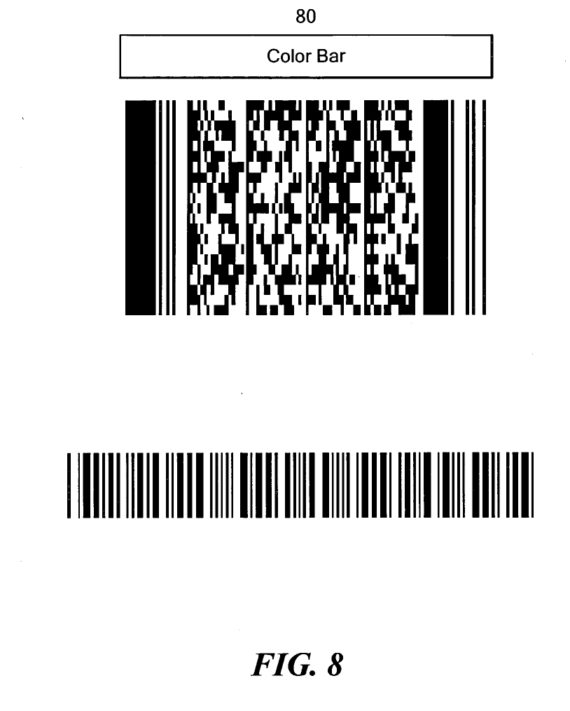

FIG. 6 is a flow chart showing an example of steps performed during step 34 of FIG. 3, in which clearing, settlement and exchange processing and other processing and handling activities are performed in an illustrative embodiment. At step 60, the item is received for processing or handling activities at a processing or handling site of the institution for settlement and exchange processing. At step 62 the bar code and/or related symbology on the item is scanned or otherwise read. Further at step 62, supplemental information may be added or otherwise provided through manual or electronic means or other technology to a database entry associated with the item through a graphical user interface provided by the disclosed system. At step 64, one or more additional bar codes and/or related symbologies may be added to reflect various processing steps for the item. Reports in either paper or electronic form may also be generated at step 66, for use by the institutions. At step 68, the item is released for example for exchange, returned by the issuing institution or stored for post processing activities.

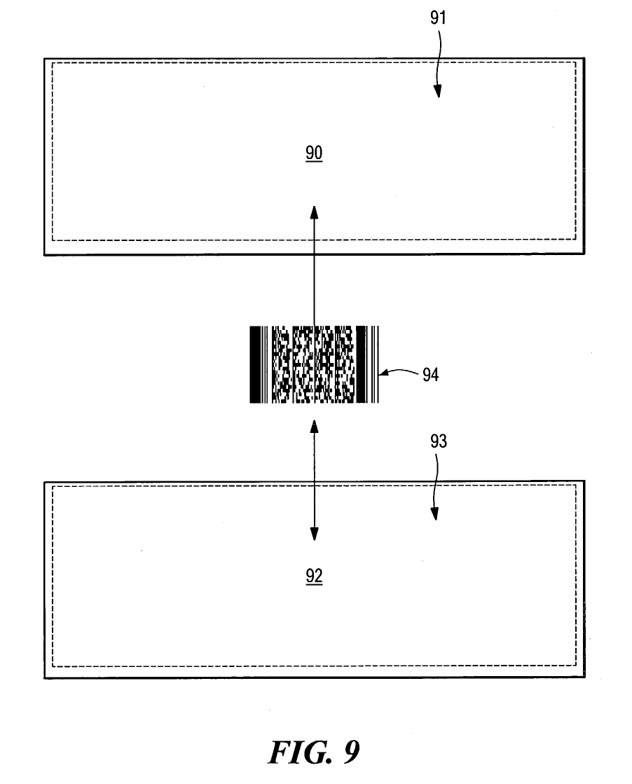

FIG. 7 is a flow chart showing steps performed during step 36 of FIG. 3, for post clearing, settlement and exchange processing in an illustrative embodiment. At step 70 the item is released or received for exchange and settlement. At step 72 the bar code(s) and/or related symbologies on the item are scanned, and one or more additional bar codes and/or related symbologies may be added to the item. Supplemental information may also be added or otherwise provided through manual or electronic means or other technology to the database entry associated with the item, for example through a graphical user interface provided by the disclosed system. The item may be retrieved and the information on the item compared with various reports and statements, which may also be in either paper or electronic form. Such comparisons may, for example, be performed either visually, through display in a graphical user interface generated by the disclosed system. Supplemental information or information otherwise provided through manual or electronic means or other technology may be entered into the database entry associated with the item at step 74. The item is then used at step 76 for post-settlement activities, such as being provided with a statement or report, and/or archiving of the item.

FIGS. 2-7 are flowchart illustrations of methods, apparatus (systems) and computer program products according to the invention. It will be understood that various specific blocks within the flowchart illustrations, and combinations of blocks in the flowchart illustrations, can be implemented by computer program instructions or otherwise provided through manual or electronic means or other technology. These computer program instructions or otherwise provided instructions through manual or electronic means or other technology may be loaded onto a computer or other programmable data processing apparatus to produce a machine, such that the instructions which execute on the computer or other programmable data processing apparatus create means for implementing the functions specified in the flowchart block or blocks. These computer program instructions or otherwise provided manual or electronic means or other technology may also be stored in a computer-readable memory that can direct a computer or other programmable data processing apparatus or other electronic means or technology to function in a particular manner, such that the instructions stored in the computer-readable memory form an article of manufacture including instruction means which implement the function specified in the flowchart block or blocks. The computer program instructions or otherwise provided instructions through manual or electronic means or other technology may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Accordingly, blocks of the flowchart illustrations support combinations of manual, electronic or other means for performing the specified functions, combinations of steps for performing the specified functions and program instruction means for performing the specified functions, in combination with various hardware devices, such as scanners and/or devices for affixing and/or printing one or more bar codes and/or related symbologies on an item. It will also be understood that various blocks of the flowchart illustrations, and combinations of blocks in the flowchart illustrations, can be implemented by special purpose hardware-based computer systems which perform the specified functions or steps, and/or in combinations of special purpose hardware devices operating under the direction of computer devices executing software instructions consistent with the flow charts. For example, the system allows an institution to make changes to the intended processing of an item such as redirecting the settlement to an alternate account held by a client when funds are insufficient without reissuing another item. The bar code on the item can be linked to more than one account and alternate instructions using the bar code information allow for more efficient ways to manage accounts.

Thus FIGS. 2-7 illustrate a process, and software, for identifying the exact entry point at an institution of an item before the item leaves an accepting institution for clearing, settlement exchange and/or other processing and handling activities. FIGS. 2-7 further illustrate subsequent identification and tracking of an item at any one or all stages or points of the clearing, settlement and exchange, post-processing customer service, and archival processes. FIGS. 2-7 illustrate further that detailed information regarding each item may be stored separately from the item in one or more entries of an associated database or other types of information repositories.

The information that is collected by the disclosed system and associated with an item may be used in a number of specific ways. For example, the information collected regarding a received item may be used to:

1. Populate the associated database.

2. Populate or update other electronic or other type of information repositories.

3. Confirm receipt or release of an item(s) at an institution or from any one or more other institutions.

4. Track the receipt, processing and/or release of the item at one or more of the processing points required to complete the processing of the item(s) for clearing, settlement, exchange, post settlement activities or any other customer provided services. This includes the processes involved in transporting or transmitting the items from one institution to another institution.

5. Track and/or trace the items at an institution.

6. Produce reports and statements required by the institution to track and report on the processing of the items from the point of initial receipt to the end of the complete processing and handling cycle(s) including post processing activities required to meet service commitments.

7. Provide statistical information required by institutions.

The above listed uses for the information collected regarding a received item and document is given for purposes of example only, and is not an exhaustive list of the uses or processes that may arise in various alternative embodiments of the disclosed system. Accordingly, any appropriate use of the information collected regarding a received item may be implemented for a specific application while remaining consistent with the present invention.

At various points in the steps of FIGS. 2-7, information on an item and document may be scanned or otherwise read, or the item itself may be imaged. Scanning of the bar codes and/or symbologies that were directly printed, applied on and/or affixed onto an item may, for example, be accomplished using a bar code scanner and/or equivalent other device. In such a device, typically a beam of light sweeps across the entire bar code and/or related symbology. The light that scans the bar code or related symbology translates the pattern of black and white spaces into a binary code of zeros and ones that the disclosed system, for example, application software, can recognize and process in cooperation with the associated database or other electronic or other types of information repositories. Specifically, a photo diode in the scanner transforms the reflected light into an electric signal, that is amplified and translated to a digital code in the scanner's microprocessor. The digital code is fed into the computer and stored in the associated database. Subsequently, the information resident in the database or other electronic or other types of information repositories may be used for a variety of tracking purposes, status checks, workflow and resource projections, billing reporting purposes. In an exemplary embodiment, scanner devices and a relational database management system (RDBMS) are provided to a user separately from an application computer program that embodies the logic driving the operation of the disclosed system.

Further for purposes of explanation, the bar code and/or related symbology of the disclosed system may be either:

1. Directly printed or applied on the item using a printer or printer/scanner that is equipped with bar code and/or other symbology software operable to link with the database or other electronic or other types of information repositories, or

2. Affixed to the item using a label that illustrates the bar coding and/or other symbology.

When a printer/scanner is used to print the bar code and/or other symbology on the item an image of one or both sides of the item may be created. Items bearing a label may also be scanned to create an image of one or both sides of the item. When the image or scan of the coded item is produced it is stored in the proprietary database or other information repositories in electronic or manual formats. Printers and scanners or other technology used to collect the images and the bar codes and/or symbology must conform with the processes of the disclosed system. For example, such scanners and printers or other technology must be compatible with a software application implementing the disclosed system.

As noted above in FIGS. 2-7, the information obtained from and encoded by the bar code, other symbology and/or text printed, applied or affixed to the item may be supplemented in a variety of ways and at various points in the processing of the item. Specifically, such additional information may be input directly to the database to supplement the data collected during the scanning and imaging of the bar code and/or other symbology process and any other processing or handling point. In fact, there are few restrictions, if any, on the type of information that can be input or otherwise added to the database or other electronic or other types of information repositories in association with the item. For purposes of explanation, a few examples of information pieces that can be added to the data automatically collected from the bar code and/or other symbology include:

1. Details specific to the item

exact dollar value

currency details

identifying information on the institution the item is drawn on

customer account information

links to customer account information

special handling information, if required

2. Internal handling or identification information to be included in reports.

3. Information required for external reporting.

4. Resource information to help flag surpluses or deficiencies.

5. Other customized information requests.

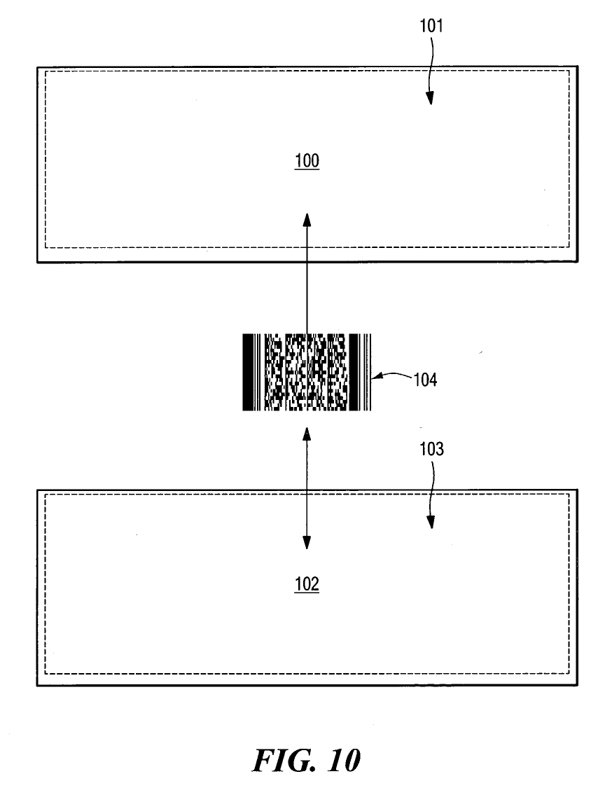

FIG. 8 shows examples of codes known as bar code 80, as may be used in an embodiment of the present invention. The illustrative bar code 80, or other symbology, may be used in the disclosed coding and tracking processes. The coded information, illustrated for purposes of example by the bar code 80, may be a single line of simple text, 2 dimensional symbologies including bar codes and/or color codes or a combination of simple text, and/or 2 dimensional symbologies including bar codes and color codes.

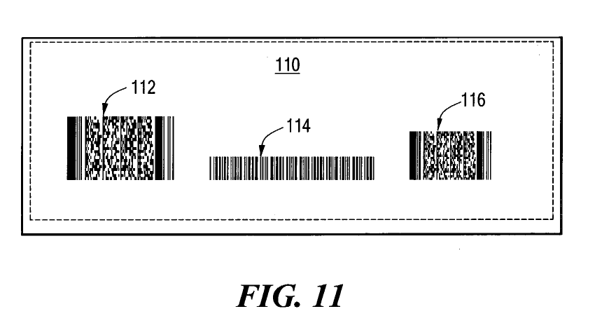

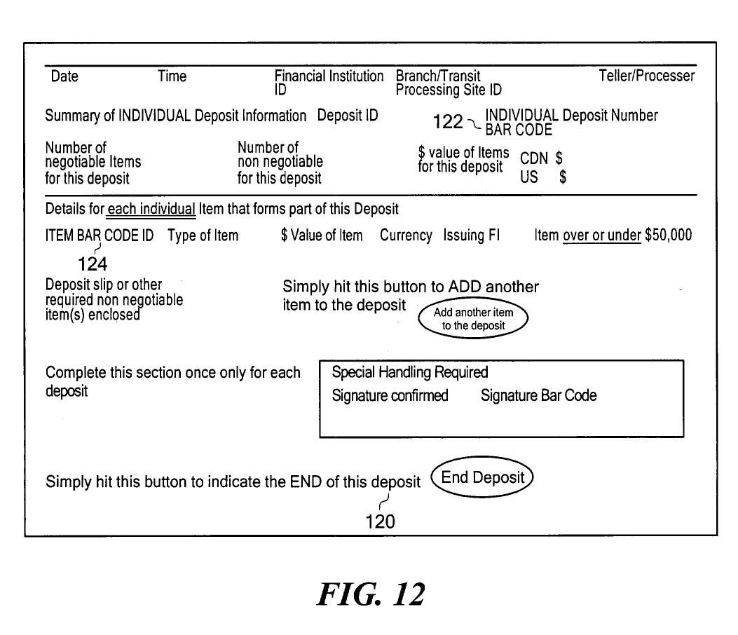

FIG. 9 illustrates the regions 90 and 92 within the surfaces 91 and 93 of an item in which bar coding 94 and/or symbology may be printed or otherwise applied or affixed using a label. For example, the surface 91 may be the back surface of an item, while the surface 93 may be the front surface of an item. The bar code 80 may be either printed horizontally or vertically in one or more of the defined areas shown in FIGS. 9 and 10, otherwise applied or affixed horizontally or vertically in one or more of the defined areas shown in FIGS. 9 and 10 using a special label. The item of FIG. 9 may be a check, or any other type of negotiable item. The region 90 may be coded with a bar code and/or other symbology. Similarly the region 92 may be using sub-regions reserved for identification of the institution that the item is drawn on or issued by, including the account number, serial number, user and/or customer created information (date, signature, and both numerical and text amount).

FIG. 10 illustrates the regions 101 and 103 within the back surface 101 and front surface 103 of an item in which bar coding 104 and/or other symbology may be printed or otherwise applied or affixed using a label. The related non-negotiable documents may be any kind of item or document, such as a deposit slip, control voucher, debit or credit voucher, or other. The regions 100 and 102 may be an area used for teller stamps or other endorsements may be replaced with bar codes and/or related symbologies.

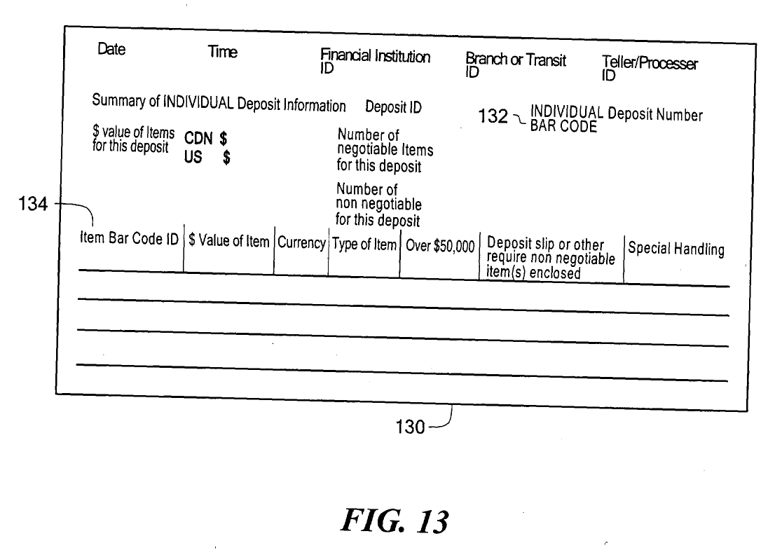

FIG. 11 shows how bar coding 112, 114, 116 and/or other symbology may appear in any space on the front or back of items. The bar coding 112, 114, and 116 may, for example, represents some combination of required regulatory information, processing point and tracking details.

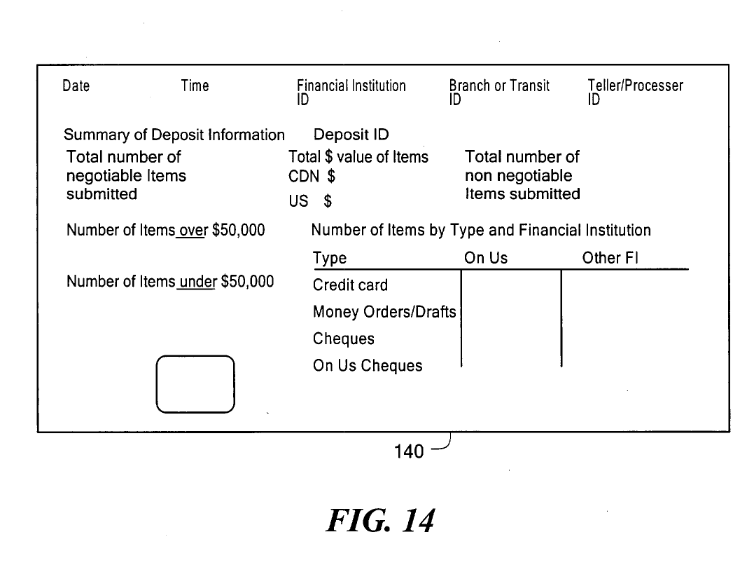

FIG. 12 shows an example of a display screen 120 provided in an illustrative embodiment for displaying a summary of a teller's deposit processing including a listing of each item in the deposit. The display screen 120 is provided through a graphical user interface, and is used to generate a Summary of Teller's Deposit processing including a listing of each item in the deposit. The Summary of Teller's deposit processing, including the information collected in the display screen 120, may then be stored electronically or on paper, and a paper copy may be affixed or attached to a deposit bag containing a number of items. The bar code 122 on the deposit bag as well as the bar codes 124 on each item will be scanned before the deposit in any format leaves an institution. The Summary of Teller's deposit processing may be sent via paper copy and/or electronic copy to institutions. The information in the Summary of Teller's deposit generated using the display screen 120 is used for tracking and balancing purposes in institutions site. Additionally, an electronic copy of the information that is sent to a subsequent processing or handling site to allow for resource planning.

The Summary of Teller's deposit processing generated using the display screen 120 further provides a record of the item(s) in the deposit for security purposes. Advantageously, most of the information fields in the display screen 120 are automatically filled from the bar code and/or other symbology applied or scanned or otherwise read from or to each item before being put sent to another institution in paper or electronic form. Those fields that are not automatically populated from the bar code and/or other symbology application or scanned are filled from a pop-up menu or filled from the connection or from links with other types of information repositories or by other means of data entry. The use of pop-up menus or pre filled fields significantly reduces the possibility of errors.

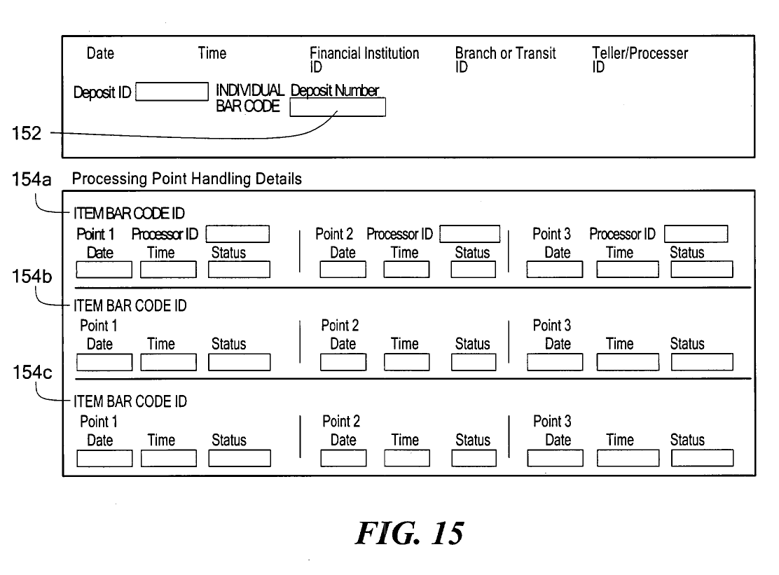

FIG. 13 shows an example of a display screen 130 provided in an illustrative embodiment for collecting and displaying information to be included in an Individual Listing Report to be sent with an item for tracking and balancing purposes or viewed online. The display screen 130 is provided as part of a graphical user interface (GUI). The Individual Listing Report generated from the information displayed in the display screen 130 may be stored and distributed in electronic and paper form. For example, the Individual Listing Report generated using the display screen 130 includes a bar code 132 identifying the deposit file or transmission containing the items and documents, as well as the bar code 134 on each item will be scanned before the deposit is physically transported or transmitted to an institution. The Individual Listing Report in the display screen 130 could be sent in hardcopy with the item(s) to an institution. The information in the Individual Listing Report is used as an audit trail for numerous purposes. Additionally, the Individual Listing Report could be used by institutions to determine resource plans. The listing further provides a record of the item for security purposes. Advantageously, most of the information fields in the display screen 130 are automatically filled when the scanning of the bar codes and/or other symbologies takes place. Those fields of the display screen 130 that are not automatically populated from the scanning of the bar codes and/or other symbologies are filled using pop-up menus and data from other information repositories and when required, data entry. The use information from bar codes and/or related symbologies significantly reduces errors and processing time.

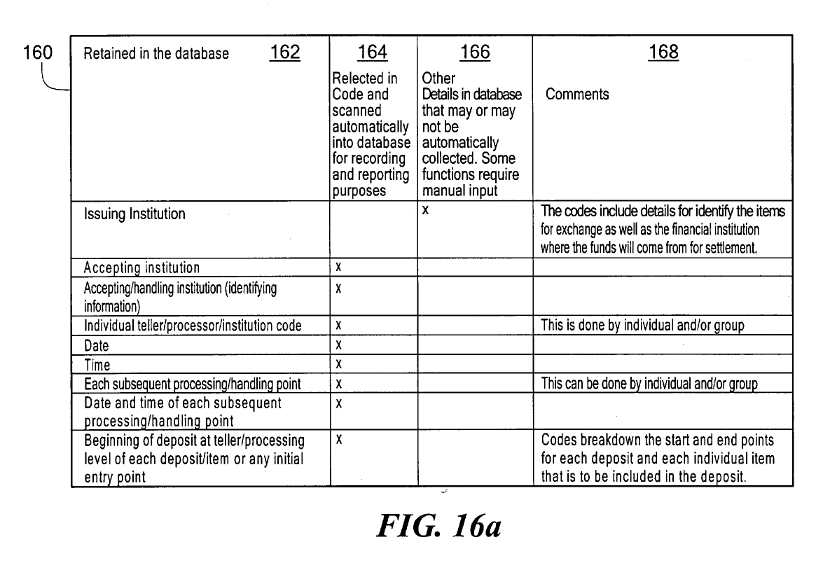

FIG. 14 shows an example of a display screen 140 provided as part of a graphical user interface (GUI) in an illustrative embodiment, for collecting and displaying the information used as an example to identify an electronic transmission containing items in an associated deposit, as well as for example the bar codes 144 on each item in the deposit will be scanned and displayed in the display screen 140 before the items and documents physically or electronically leave institutions. This internal report is sent distributed as determined by an institution. The information in this report could be used by:

Cash Management functions and activities at internal and external levels such as governmental reporting are maximized as reporting on the processing and handling of each item for tracking settlement and exchange activities as information is available in real time and at any point of the settlement and exchange processes and handling activities.

Other sites at institutions are provided with information that helps determine resource and equipment planning that can reduce holdover and expedite the processing and handling of items.

Additionally, the report allows for pinpointing and otherwise identifying processing, handling problems as well as mismanagement and misuse of the items and documents. The information in the report is collected and retained in the database or other types of information repositories. Cumulative totals may also be made available in other report formats.

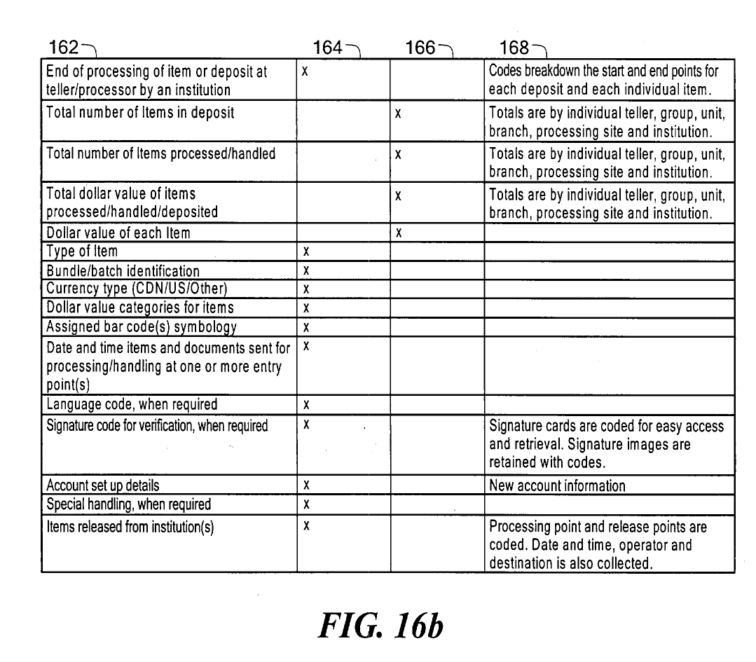

FIG. 15 shows an example of a display screen 150 provided in an illustrative embodiment for collecting and displaying information, including an associated deposit bar code 152, used to generate a Tracking and Processing report. The bar codes 154a, 154b, and 154c on each item are scanned at any one or more processing points to capture date, time and processing status. This information could be linked to a billing report for outsourced or internal services. The information in this report can be used by:

The accepting institution to track any one or more processing and handling activities.

Any other institutions involved in the handling and processing of items and documents to analyze and better manage processes and procedures.

Institutions to provide information required in legal proceedings.

Illustrative Database Embodiment

The bar code and/or related symbology database or other types of information repositories may be embodied to operate on a variety of operating systems, including, for purposes of example, both Apple Mac or IBM PC type operating systems. Similarly, the application software supporting the disclosed process also may, for example, run on both IBM PC and Apple Mac operating systems, and operate in cooperation with laser and/or inkjet type printers or other technologies.

The database or other types of information repositories created to support the processes of the disclosed systems contain a collection of related information stored in a pre-determined structural format. The database or other types of information repositories consist of multiple tables linked together by pre-determined logical relationships representing functional or operational relationships that are common to most institutions responsible for issuing or accepting items for the purposes of clearing, settlement and exchange. Customized data formats may also be accounted for in the disclosed database or other electronic or other types of information repositories. Such a multi-table database format is typically classified as a “relational” database. An external database management system (program) is used to organize the data and the structure of the data within the database and other types of information repositories. The database management system is linked via interface software program allowing the information collected on an item to be converted to a unique bar code and/or related symbology labeling or printer or applicator technology and reading and conversion program(s) designed specifically for use with the database or other electronic types of information repositories. As will be recognized by those skilled in the art, the fields in each layout of the database and other types of information repositories describe a single aspect of each member of a table. The values and attributes of each of the fields are uniquely assigned by the inventor to create the elements and functionality of the database and process in the disclosed system. Further, the database includes query functions that are designed to organize and simplify the process of extracting information from the database or other types of information repositories in a series of usable forms. The query views combine various fields and tables designed to extract key information elements from the summary table.

Protecting Files

The database and other types of information repositories contain a series of security features. The entire database or any part of the database including access and functionality can be limited at various levels. Access and functionality privileges are designed to be at single or multi levels. Passwords used in the database may, for example, be independent of system access privileges. The database “host” system or determines access rights, as the data is only accessible when the host is connected and accessible.

Information can be exchanged (imported and exported) with files from the database or other types of information repositories or files created in other applications. In this context, the term “import” refers to bringing data from another compatible file into the database, and the term “export” means to save database file(s) in a format compatible with other applications. For example, applications used to create the database may support the following formats:

Tab separated Text

Comma-separated text

SYLK

DIF

WKS

BASIC

Merge

HTML Table

Edition File

DBF

Excel

Further for example, in one embodiment, only text may be exported or imported, while other attributes may not.

The database associated with the disclosed system can be used on the World Wide Web (“Web”). In one embodiment, the application used to create the database provides for a Web companion program to act as a Common Gateway Interface (CGI) application between the database application and Web browser software.

Data Collection, Scanning, Imaging Input and Transmission and Delivery Using another Method i.e. Physical Transfer

The bar code and/or symbology printed from the information in the database or other types of information repositories and/or scanned into the database are used to populate most of the fields in each record and table in the database. When information is to be entered into the database, a pop-up menu of predetermined responses may be provided or information from other repositories can be automatically provided resulting in pre filled fields significantly reducing the error ratio for inputting or transposing incorrect information. The menu requires the user(s) to click on one of the predetermined responses. The scanning of the bar codes and/or related symbology used in the process described in this patent further reduces the chance of error. The information in the bar code and/or related symbology is also predetermined and categorized to meet the needs of most institutions responsible for issuing, accepting, processing and otherwise handling items.

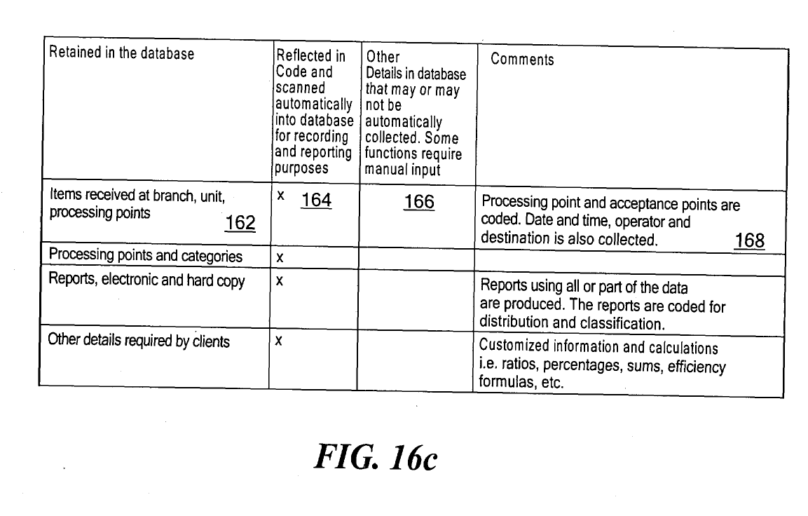

FIGS. 16a, 16b and 16c illustrate types of information that can be stored in a code printed, applied or affixed to an item and document or activity associated with the item. The table 160 is shown having four columns: 1) column 162, storing the identity or name describing each data entry or activity in the table, 2) column 164, indicating which of the entries or activities in the table describe information encoded in the bar coding and/or related symbology that is printed, applied or affixed to each item processed by the disclosed system, 3) column 166, indicating which of the entries in the table describe information that is stored in the database or other types of information repositories but that is not encoded in the bar coding and/or related symbology or text that is printed, applied or affixed to each item processed by the disclosed system, including supplemental information entered into the system through the graphical user interface (GUI), and 4) comments regarding the entries in the table 160.

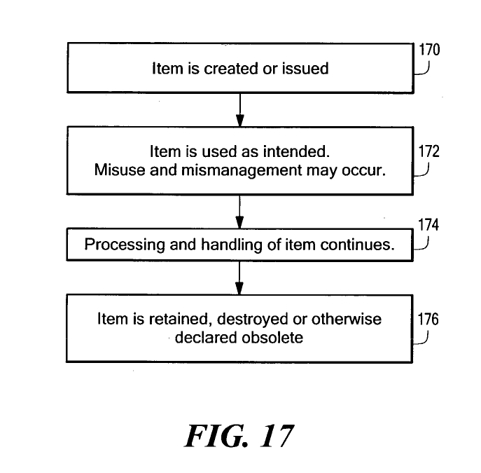

FIG. 17, illustrates the typical lifecycle stages of an item from creation or issuance through to the final stages of destruction, storage or obsolescence. While the stages illustrated here are summarized the actual lifecycle in time is not represented in the diagram.

At step 170, the item is created or issued for distribution or circulation. In steps 172 and 174, the item is used as intended and the required processing and handling continues. Misuse and mismanagement may occur at any stage throughout the lifecycle of the item. Finally, at step 176, the item reaches it maturity or end of lifecycle stage. Depending on the type and use of the item the final lifecycle stages vary.

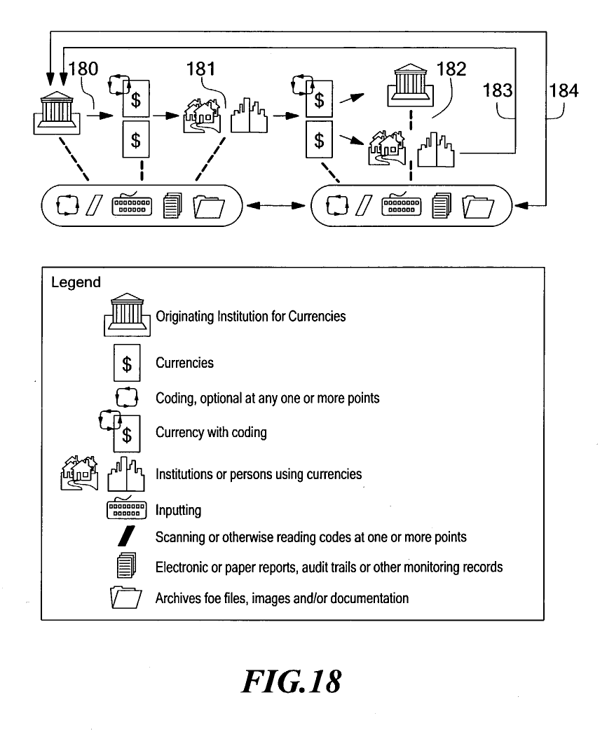

As illustrated in FIG. 18, the disclosed system provides for assignment or scanning of the bar code and/or related symbology on an item such as currency, adding of additional bar codes and/or other symbologies or capture of supplemental information, recording, storing recalling, archiving and destruction of the item and other processing and handling stages throughout the lifecycle of the item as well as any transactional usage whether intended or considered a misuse of the item.

At step 180 the item such as currency is created and issued for distribution and circulation. Next, at step 181, the item is used or processed throughout the lifecycle of the item. At step 182 the item continues to be used or processed as required. For example, the item could be deemed ineligible for use and recalled for destruction. Finally, at steps 183 and 184, the disclosed system facilitates the information used to create an audit of the item throughout its lifecycle.

The disclosed systems provide significant advantages over previous systems in many areas. The disclosed systems improve timeliness in handling and processing by eliminating delays in processing the item from any one or more processing or handling points of institutions to other stages in the lifecycle of the item and document. The system reduces the time and resources spent on balancing and reconciling items and documents, preparing items for settlement and exchange, and for identifying, tracing and resolving problems related to the item. In another embodiment, when the item is in the form of currency additional advantages are apparent such as monitoring illegal acts, monitoring the use of currency to complete transactions, physical location of the item at anytime as well as the ability to recall, destroy or otherwise curtail the use of the item at any stage in the lifecycle of the item.

In the area of security, each item is recorded, accounted for and documented in the disclosed before leaving one or more institutions. When the disclosed coding process is combined with a remote, on-site image capture process, security is further enhanced as images of an item are retained prior to the items physically leaving a branch or transmitted to other institutions.

The disclosed system enables more accurate process accountability, since the disclosed bar coding and/or related symbology and tracking provides details on when, where and who was responsible for the processing of each item. The bar codes and/or related symbologies may be used to identify any one or more point(s) and person(s) responsible for the processing of each item. The database records associated with the item allow for checking and verification of internal processes and ensure increased accountability, accuracy and quality while at the same time reducing operating expenses and time spent on correcting errors.

The disclosed system further increases eligibility and identification controls. Specifically, the disclosed bar coding and/or related symbology and tracking process ensures the authenticity of the institutions' employees and subcontractors, thereby reducing the opportunity for mishandling or misuses of items.

With regard to handling and servicing charges, the disclosed bar coding and/or related symbology and tracking process may be used to provide detailed time and productivity indicators that can be used to reduce handling and processing charges for institutions, while also monitoring service levels.

The disclosed bar coding and/or related symbology and tracking database provides reports that can pinpoint hourly, midday, daily or other time segmented volume counts and fluctuations. This information can be segmented by numerous subgroups to help identify when and where additional or reduced resources are required to meet service levels and processing deadlines while identifying problems

In a further improvement over existing systems, the disclosed techniques may provide significant reductions in balancing and control errors, resulting in fewer corrections and financial adjustments. The coding and tracking information collected by the disclosed system improves balancing and control functions at all process levels, including: any one or more points of entry or processing, transfer for clearing, settlement and exchange. The resulting improvements in balancing and control functionality reduce the number of errors and post-processing adjustments required to offset errors.

A significant reduction in the time spent tracking errors and financial documents may also be achieved using the disclosed system, since the bar coding and/or related symbology and tracking information it provides can reduce the amount of time and resources required to locate processing details, images and actual documents. The access to the tracking data without having to locate the actual item or document eliminates system and technology time delays due to the sheer size of image files or physically locating the item or document. As a result, it is less difficult to identify precisely where and when the item and document was last handled or processed. Tracking back to a problem source can therefore be done automatically by scanning the bar code and/or related symbology, entering the bar code, recalling any one or more information pieces about the item.

The ease of accessing information is a significant improvement over what is currently available. For example: Recalling information for an item is done by simply entering a point of entry, teller name, a processing or handling point, date or time reference.

Moreover, items and documents may be automatically linked to the associated database at any one or more points of entry or when any one or more processing or handling activity occurs.

The disclosed system provides international adaptation as it is not dependent upon the language of any particular country. The bar coding and/or related symbologies in the system are scanned, applied and decoded into universal and language specific applications. The system can be linked to information in the language(s) required by the user.

And finally, the disclosed system may improve regulatory and business related reporting, since the associated database provides detailed information that can be used to produce regulatory and business reports, at any required time frequency, and a number of formats.

Those skilled in the art should readily appreciate that programs defining the functions of the disclosed system and method can be implemented in software and delivered to a system for execution in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using baseband signaling or broadband signaling techniques, including carrier wave signaling techniques, such as over computer or telephone networks via a modem. In addition, while the illustrative embodiments may be implemented in computer software, the functions within the illustrative embodiments may alternatively be embodied in part or in whole using hardware components such as Application Specific Integrated Circuits, Field Programmable Gate Arrays, or other hardware, or in some combination of hardware components and software components.

While the invention is described through the above exemplary embodiments, it will be understood by those of ordinary skill in the art that modification to and variation of the above described methods and system may be made without departing from the inventive concepts herein disclosed. Accordingly, the invention should not be viewed as limited except by the scope and spirit of the appended claims.

What is claimed is:

1. A method for processing an item, comprising:
receiving said item for said processing;
associating, in response to said receiving of said item, a bar code with said item, wherein said bar code uniquely identifies said item for an institution, and wherein said bar code further indicates an entity associated with the processing of said item;
storing, in response to said associating of said bar code with said item, information related to said item in a database; and
associating said information related to said item with said bar code.

2. The method of claim 1, wherein said processing is clearing of said item.

3. The method of claim 1, wherein said processing is settlement and exchange of said item.

4. The method of claim 1, wherein said processing is post settlement processing of said item.

5. The method of claim 1, wherein said item is a negotiable instrument.

6. A method for processing a document comprising:
receiving said document for said processing;
associating, in response to said receiving of said document, a bar code with said document, wherein said bar code uniquely identifies said document for an institution, and wherein said bar code further indicates an entity associated with the processing of said document;
storing, in response to said associating of said bar code with said document, information related to said document in a database; and
associating said information related to said document with said bar code.

7. The method of claim 1, wherein said entity associated with said item comprises a location at which said bar code was initially received.

8. The method of claim 1, wherein said entity associated with said item comprises a person associated with said processing of said item.

9. The method of claim 1, further comprising associating, responsive to detection of a predetermined condition, a second bar code with said item, wherein said second bar code indicates a special processing status associated with said item.

10. The method of claim 9, wherein said predetermined condition comprises a value of said item exceeding a predetermined limit.

11. The method of claim 1, wherein said at least one portion of data indicates issuing institutions with regard to said item.

12. The method of claim 1, wherein said bar code indicates a value in a predetermined currency associated with said item.

13. The method of claim 1, wherein said bar code indicates a currency associated with said item.

14. The method of claim 1, wherein said bar code indicates a customer account associated with said item.

15. The method of claim 14, wherein said associating said bar code with said item further comprises printing said bar code onto said item.

16. The method of claim 15, wherein said associating said bar code with said item further comprises applying or affixing a label including said bar code onto said item.

17. The method of claim 1, wherein said receiving of said item comprises receiving an electronic transmission of said item.

18. The method of claim 17, wherein said associating said bar code with said item further comprises associating an electronic copy of said bar code with said electronic copy of item.

19. The method of claim 1, wherein said bar code includes an indication of an accepting institution.

20. The method of claim 19, wherein said bar code includes an indication of an entry point in said institution at which said item was received.

21. The method of claim 19, wherein said bar code includes an indication of a person responsible for processing said item at said institution.

22. The method of claim 1, wherein said bar code includes an indication of a date on which said item was received for processing.

23. The method of claim 1, wherein said bar code includes an indication of a time at which said item was received for processing.

24. The method of claim 7, further comprising associating an additional bar code with said item wherein said additional bar code indicates a processing point subsequent to said location at which said item was initially received.

25. The method of claim 7, further comprising associating at least one additional bar code with said item, wherein said at least one additional bar code indicates a time said item was received at a processing point subsequent to said location at which said item was initially received.

26. The method of claim 1, wherein said bar code further includes indication of a cumulative deposit associated with said item.

27. The method of claim 26, wherein said bar code further includes indication of a total number of items included in said cumulative deposit.

28. The method of claim 1, wherein said bar code further includes indication of a type of said item.

29. The method of claim 28, wherein said indication of said type of said item indicates that said item is an accepted item.

30. The method of claim 1, wherein said bar code indicates a currency associated with said item.

31. The method of claim 1, further comprising creation of an electronic version of one or more parts of said item.

32. The method of claim 1, further comprising affixing related symbology to said item.

33. The method of claim 1, wherein said associating said bar code with said item includes scanning said bar code.

34. The method of claim 1, further comprising determining at least one fee to be collected in responsive to said associating said bar code with said item.

35. A system for processing an item, comprising:
means for receiving said item for said processing;
means for associating, in response to said means for receiving of said item, a bar code with said item, wherein said bar code uniquely identifies said item for an institution, and wherein said bar code further indicates an entity associated with the processing of said item;
means for storing, in response to said associating of said bar code with said item, information related to said item in a database; and
means for associating said information related to said item with said bar code.

36. An item having a bar code, for use in a system for processing said item, wherein said system for processing said item is operable to:
receive said item for said processing;
associate, in response to said receipt of said item, said bar code with said item, wherein said bar code uniquely identifies said item for an institution, and wherein said bar code further indicates an entity associated with the processing of said item;
store, in response to said association of said bar code with said item, information related to said item in a database; and
associate said information related to said item with said bar code.

37. A method for processing a negotiable instrument, comprising:
receiving said negotiable instrument for clearing through at least one financial institution;
associating, in response to said receiving of said negotiable instrument for clearing, a bar code with said negotiable instrument, wherein said bar code uniquely identifies said negotiable instrument in said at least one financial institution, and wherein said bar code further indicates an entity associated with said processing of said negotiable instrument;
storing, in response to said associating of said bar code with said negotiable instrument, information related to said negotiable instrument in a database; and
associating said information related to said negotiable instrument with said bar code.

38. A method for processing an item, wherein said item comprises an item of currency, comprising:
creating said item, wherein said item includes a bar code readable thereon;
associating said bar code with said item, wherein said bar code uniquely identifies said item for an institution;
storing, in response to said associating of said bar code with said item, information related to said item in a database; and
associating said information related to said item with said bar code.

39. The method of claim 38, further comprising inputting said bar code in at least one processing point during a lifecycle of said item.

40. The method of claim 38, further comprising reading said bar code in at least one processing point during a lifecycle of said item.

41. The method of claim 39, further comprising generating at least one report responsive to said inputting of said bar code in said at least one processing point during said lifecycle of said item.

42. The method of claim 40, further comprising generating at least one report responsive to said reading of said bar code in said at least one processing point during said lifecycle of said item.

43. A system for processing an item, wherein said item comprises an item of currency, comprising:
means for creating said item, wherein said item includes a bar code readable thereon;
means for associating said bar code with said item, wherein said bar code uniquely identifies said item for an institution;
means for storing, in response to said means for associating of said bar code with said item, information related to said item in a database; and
means for associating said information related to said item with said bar code.

44. The method of claim 1, further comprising performing a step of creating said item.

45. The method of claim 1, further comprising performing an end of lifecycle step with regard to said item.

46. The method of claim 38, further comprising performing an end of lifecycle step with regard to said item.
